(19) United States
(12) Patent Application Publication
(10) Pub. No.: US 2025/0351135 A1
(43) Pub. Date: Nov. 13, 2025

(54) METHODS, DEVICES, AND SYSTEMS FOR SCHEDULING MECHANISM

(71) Applicant: ZTE Corporation, Shenzhen (CN)

(72) Inventors: Jing SHI, Shenzhen (CN); Xianghui HAN, Shenzhen (CN); Shuaihua KOU, Shenzhen (CN); Xingguang WEI, Shenzhen (CN)

(21) Appl. No.: 19/222,867

(22) Filed: May 29, 2025

Related U.S. Application Data
(63) Continuation of application No. PCT/CN2023/076821, filed on Feb. 17, 2023.

(51) Int. Cl. H04W 72/1263

(52) U.S. Cl. CPC H04W 72/1263

(57) ABSTRACT

The present document describes methods, system, and devices for wireless communication, and more specifically, for scheduling mechanism with multiple carriers in one cell. One method is performed by a wireless communication device and includes receiving a configuration comprising scheduling information for a carrier in a cell, wherein the cell comprises a plurality of carriers; and deriving a set of parameters of the configuration for the carrier. Another method is performed by a wireless communication node, and includes determining a set of parameters of a configuration for a carrier in a cell, wherein the cell comprises a plurality of carriers; and sending the configuration comprising scheduling information for the carrier.

### CROSS REFERENCE TO RELATED APPLICATIONS

This patent document is a continuation of and claims benefit of priority to International Patent Application No. PCT/CN2023/076821, filed on Feb. 17, 2023. The entire content of the before-mentioned patent application is incorporated by reference as part of the disclosure of this application.

### TECHNICAL FIELD

The present disclosure is directed generally to wireless communications. Particularly, the present disclosure relates to methods, devices, and systems for scheduling mechanism.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

Carrier aggregation (CA) is used to improve the performance of wireless communication system in 4G and 5G and further communication system. CA may increase data rate per user equipment (UE) by assigning multiple component carriers in the frequency domain to a same UE. In some implementations of employing CA, scheduling mechanism may only allow scheduling of single cell physical uplink shared channel (PUSCH) and/or physical downlink shared channel (PDSCH) per a scheduling downlink control information (DCI). With more available scattered spectrum bands, the need of simultaneous scheduling of multiple cells is expected to be increasing. To reduce the control overhead, it is beneficial to extend from single-cell scheduling to multi-cell PUSCH/PDSCH scheduling with a single scheduling DCI. When multiple carriers in one cell is supported, there are various problems/issues associated how to schedule the PDSCH/PUSCH on each carrier.

The present disclosure describes various embodiments for scheduling mechanism with multiple carriers in one cell, addressing at least one of the issues/problems discussed in the present disclosure.

### SUMMARY

This document relates to methods, systems, and devices for wireless communication, and more specifically, for scheduling mechanism with multiple carriers in one cell.

In one embodiment, the present disclosure describes a method for wireless communication. The method is performed by a wireless communication device. The method includes receiving a configuration comprising scheduling information for a carrier in a cell, wherein the cell comprises a plurality of carriers; and deriving a set of parameters of the configuration for the carrier.

In one embodiment, the present disclosure describes a method for wireless communication. The method is performed by a wireless communication node. The method includes determining a set of parameters of a configuration for a carrier in a cell, wherein the cell comprises a plurality of carriers; and sending the configuration comprising scheduling information for the carrier.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows a schematic diagram of an exemplary embodiment for wireless communication.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5A shows a schematic diagram of an exemplary embodiment for wireless communication.

FIG. 5B shows a schematic diagram of another exemplary embodiment for wireless communication.

FIG. 5C shows a schematic diagram of another exemplary embodiment for wireless communication.

FIG. 5D shows a schematic diagram of another exemplary embodiment for wireless communication.

FIG. 6A shows a schematic diagram of another exemplary embodiment for wireless communication.

FIG. 6B shows a schematic diagram of another exemplary embodiment for wireless communication.

FIG. 6C shows a schematic diagram of another exemplary embodiment for wireless communication.

FIG. 6D shows a schematic diagram of another exemplary embodiment for wireless communication.

FIG. 7 shows a schematic diagram of another exemplary embodiment for wireless communication.

FIG. 8A shows a schematic diagram of another exemplary embodiment for wireless communication.

FIG. 8B shows a schematic diagram of another exemplary embodiment for wireless communication.

FIG. 8C shows a schematic diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for scheduling mechanism with multiple carriers in one cell.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

The 4th Generation mobile communication technology (4G) Long-Term Evolution (LTE) or LTE-Advance (LTE-A) and the 5th Generation mobile communication technology (5G) face more and more demands. Based on the current development trend, 4G and 5G systems are developing supports on features of enhanced mobile broadband (eMBB), ultra-reliable low-latency communication (URLLC), and massive machine-type communication (mMTC).

Carrier aggregation (CA) is used to improve the performance of wireless communication system in 4G and 5G and further communication system. CA may increase data rate per user equipment (UE) by assigning multiple component carriers in the frequency domain to a same UE. In some implementations of employing CA, scheduling mechanism may only allow scheduling of single cell physical uplink shared channel (PUSCH) and/or physical downlink shared channel (PDSCH) per a scheduling downlink control information (DCI). With more available scattered spectrum bands, the need of simultaneous scheduling of multiple cells is expected to be increasing. To reduce the control overhead, it is beneficial to extend from single-cell scheduling to multi-cell PUSCH/PDSCH scheduling with a single scheduling DCI.

When multi-cell scheduling with a single scheduling DCI format (e.g., format 0_X and/or 1_X) are introduced for a set of cells, a DCI size of the DCI format 0_X/1_X is counted on one cell among the set of cells, a blind decode and/or control channel element (BD/CCE) of the DCI format 0_X/1_X is counted on one cell among the set of cells. Search space (SS) of the DCI format 0_X/1_X is configured on one cell of the set of cells and associated with the search space of the scheduling cell with the same search space identifier (ID). For monitoring PDCCH candidates for a set of cells which is configured for multi-cell scheduling, a value of n_CI in the search space equation is determined by a value configured for the set of cells. In some implementations, there is only one DL carrier in one cell, and for a cell, there may be no uplink (UL) carrier, or one UL carrier, or one UL carrier with further configured at most one supplementary uplink (SUL) carrier.

With more available scattered spectrum bands, the need of simultaneous utilizing of multiple carriers in one cell is expected to be increasing. CA mechanism may benefit the UEs in a connected mode and/or current SUL mechanism only support one SUL carrier. In some implementations, some scheduling mechanism allow scheduling of single cell PUSCH/PDSCH per a scheduling DCI, and multi-cell PUSCH/PDSCH scheduling with a single scheduling DCI to reduce the control overhead. There are various problems/issues when multiple carriers in one cell is supported, for example but not limited to, how to schedule the PDSCH/PUSCH on each carrier.

The various embodiments and implementations described in the present disclosure include methods and devices for scheduling mechanism with multiple carriers in one cell, addressing at least one of the issues/problems discussed in the present disclosure.

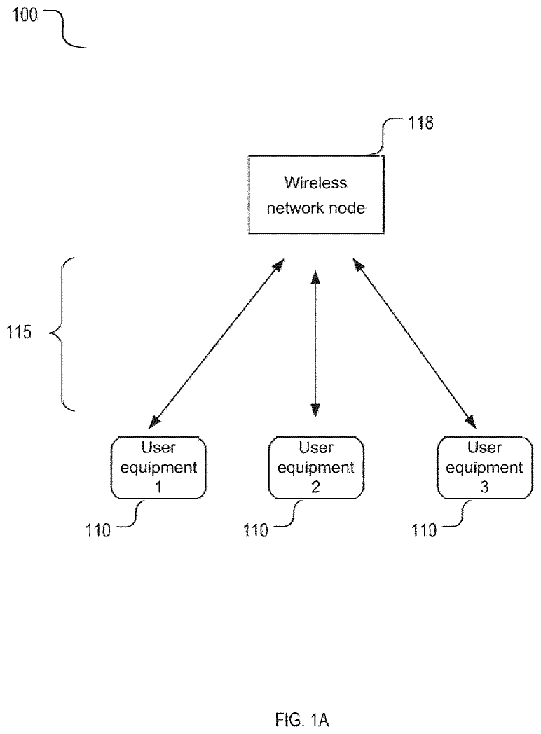

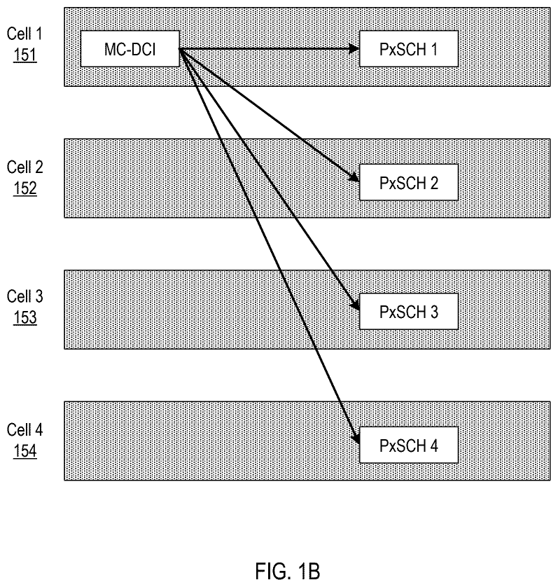

FIG. 1A shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

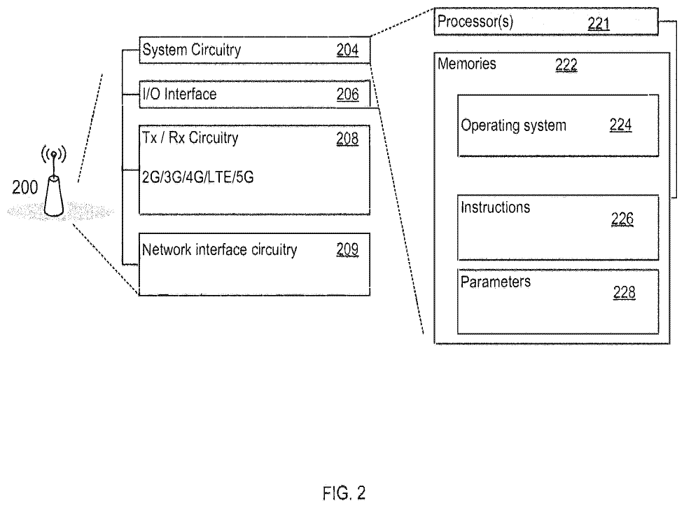

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

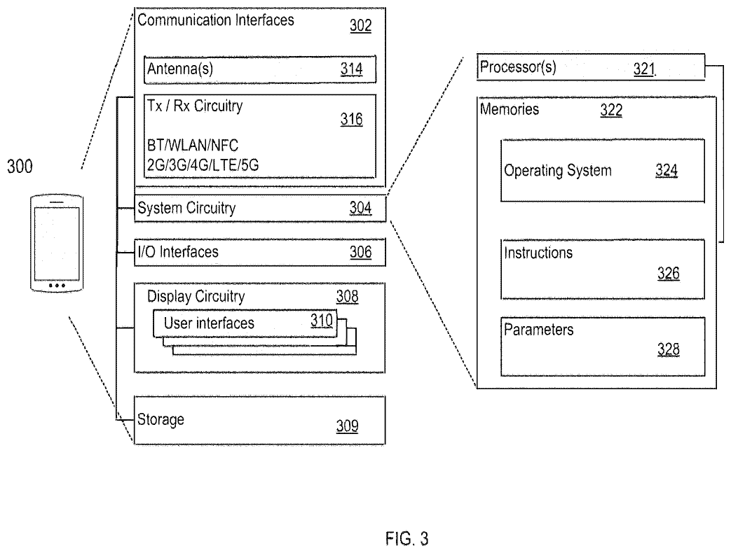

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for scheduling mechanism with multiple carriers in one cell, which may be implemented, partly or totally, on the network base station and/or the user equipment described above in FIGS. 2-3. The various embodiments in the present disclosure may enable efficient wireless transmission in the telecommunication system, which may increase the resource utilization efficiency and/or boost latency performance of URLLC traffic.

In some implementations for multi-cell scheduling, under a normal situation, one scheduled cell may be only configured with single scheduling cell. FIG. 1B shows a multi-cell scheduling, wherein a first cell (Cell 1, 151) may be a scheduling cell, a second cell (Cell 2, 152) may be a scheduled cell, a third cell (Cell 3, 153) may be another scheduled cell, and a fourth cell (Cell 4, 154) may be another scheduled cell. A scheduled cell may be only configured with one scheduling cell and a single multi-cell scheduling DCI (MC-DCI), which may be a DCI format 0_X/1_X and carried by PDCCH, may be used to schedule multi-PxSCH on multi cells, with each PxSCH on one cell. The term “PxSCH” may be used to refer to either a physical downlink shared channel (PDSCH) or a physical uplink shared channel (PUSCH). In some implementations, the PDCCH may be called as a control channel, and the PxSCH may be called as a data channel.

As shown in FIG. 1B, there is only one scheduling cell for a scheduled cell, and MC-DCI and/or single cell scheduling DCI (SC-DCI), which is a legacy DCI forma (e.g. DCI format 0_1/1_1), may be supported on the scheduling cell for a scheduled cell. MC-DCI may be a new DCI format 0_X/1_X.

In some implementations, for example in a normal case, a DCI size and/or blind decode/control channel element (BD/CCE) of the PDCCH carried the multi-cell scheduling DCI are counted on one cell among the set of cells. In some implementations, the BD is corresponding to the Maximum number

$${M}_{PDCCH}^{max , slot , μ}$$

of monitored PDCCH candidates per slot/span for a downlink (DL) bandwidth part (BWP) with a subcarrier spacing (SCS) configuration μ∈{0, 1,2,3} for a single serving cell. The CCE is corresponding to the maximum number

$${C}_{PDCCH}^{max , slot , μ}$$

of non-overlapped CCEs per slot/span for a DL BWP with SCS configuration μ∈{0, 1,2,3} for a single serving cell.

In some implementations, there may be at least two conditions for multiple cell scheduling.

One condition: for a set of cells configured for multi-cell scheduling, existing DCI size budget is maintained on each cell of the set of cells; DCI size of DCI format 0_X/1_X is counted on one cell among the set of cells (e.g., DCI size of the DCI format 0_X/1_X being counted on the reference cell); BD/CCE of DCI format 0_X/1_X is counted on one cell among the set of cells (e.g., BD/CCE of the DCI format 0_X/1_X being counted on the reference cell); same reference cell is used for both DCI format 0_X and DCI format 1_X.

The condition may further include that, for a set of cells configured for multi-cell scheduling, the reference cell is: the scheduling cell when the scheduling cell is included in the set of cells and search space of the DCI format 0_X/1_X is configured only on the scheduling cell; one cell of the set of cells which search space of DCI format 0_X/1_X is configured on and associated with the search space of the scheduling cell with the same search space ID when search space of the DCI format 0_X/1_X is configured on the cell in addition to the scheduling cell, e.g., it is up to gNB on which cell the SS of the DCI format 0_X/1_X is configured on.

The condition may further include that, for a set of cells configured for multi-cell scheduling, to address BD/CCE limit for any given cell: for the reference cell, a total number of configured BD/CCEs for both DCI formats 0_X/1_X and legacy DCI formats (if configured) does not exceed a pre-defined limits; for other cells in the sets of cells, one or more predefined limits for PDCCH/DCI monitoring and BD/CCE counting rules for legacy DCI formats (not including DCI formats 0_X/1_X) apply.

Another condition: for monitoring PDCCH candidates for a set of cells which is configured for multi-cell scheduling, the n_CI in the search space equation is determined by a value configured for the set of cells by RRC signaling.

In some implementations, there is a DCI size budget for a UE per serving cell. That is, UE is not expected to handle the total number of different DCI sizes configured to monitor is more than 4 for the cell; or the total number of different DCI sizes with C-RNTI configured to monitor is more than 3 for the cell.

In some implementations, the maximum number

$${M}_{PDCCH}^{max , slot , μ}$$

of monitored PDCCH candidates per slot for a DL BWP with SCS configuration μ∈{0, 1,2,3} for a single serving cell is shown as Table 1, wherein μ∈{0, 1,2,3} is corresponding to 15 khz, 30 khz, 60 khz and 120 khz respectively.

In some implementations, the maximum number

$${C}_{PDCCH}^{max , slot , μ}$$

of non-overlapped CCEs per slot for a DL BWP with SCS configuration μ∈{0, 1,2,3} for a single serving cell is shown as Table 2.

TABLE 1
Maximum number of monitored PDCCH candidates (or Blind
Decodes (BDs))

| | Maximum number of monitored PDCCH candidates per slot and |
|---|---|
| μ | $per serving cell {M}_{PDCCH}^{max , slot , μ}$ |
| 0 | 44 |
| 1 | 36 |
| 2 | 22 |
| 3 | 20 |

TABLE 2
Maximum number of non-overlapped CCEs

| | Maximum number of non-overlapped CCEs per slot and |
|---|---|
| μ | $per serving cell {C}_{PDCCH}^{max , slot , μ}$ |
| 0 | 56 |
| 1 | 56 |
| 2 | 48 |
| 3 | 32 |

In some implementations, when a UE is configured with

$${N}_{cells}^{DL , μ}$$

downlink cells with DL BWPs having SCS configuration μ, where

$${\sum }_{μ = 0}^{3} {N}_{cells}^{DL , μ} > {N}_{cells}^{cap}$$

a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than

$${M}_{PDCCH}^{total , slot , μ} = ⌊ {N}_{cells}^{cap} \cdot {C}_{PDCCH}^{max , slot , μ} \cdot {N}_{cells}^{DL , μ} / {\sum }_{j = 0}^{3} {N}_{cells}^{DL , j} ⌋$$

PDCCH candidates or more than

$${C}_{PDCCH}^{total , slot , μ} = ⌊ {N}_{cells}^{cap} \cdot {C}_{PDCCH}^{max , slot , μ} \cdot {N}_{cells}^{DL , μ} / {\sum }_{j = 0}^{3} {N}_{cells}^{DL , j} ⌋$$

non-overlapped CCEs per slot on the active DL BWP(s) of scheduling cell(s) from the

$${N}_{cells}^{DL , μ}$$

downlink cells.

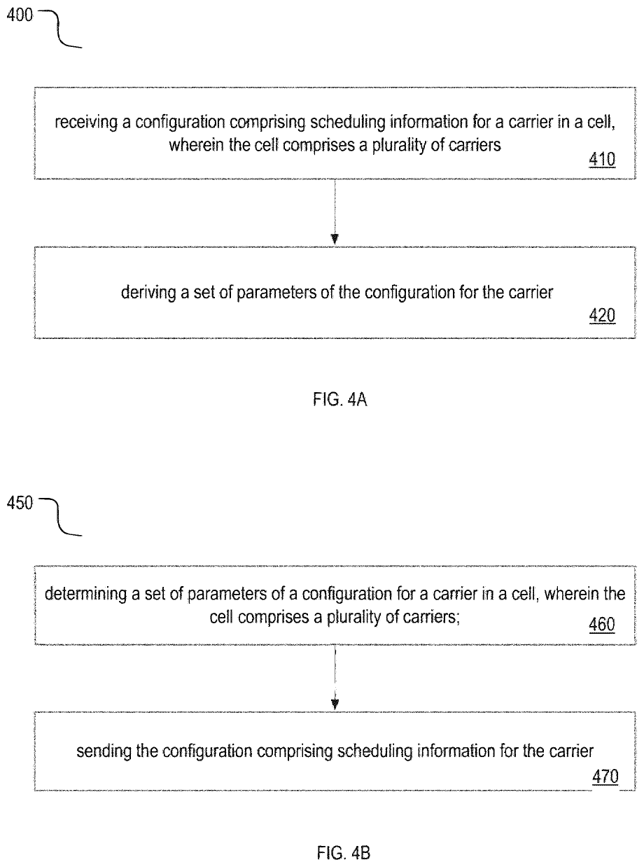

Referring to FIG. 4A, the present disclosure describes various embodiments of a method 400 for wireless communication. The method 400 may be performed by a wireless communication device (e.g., a user equipment). The method 400 may include a portion or all of the following steps: step 410, receiving a configuration comprising scheduling information for a carrier in a cell, wherein the cell comprises a plurality of carriers; and/or step 420, deriving a set of parameters of the configuration for the carrier.

Referring to FIG. 4B, the present disclosure describes various embodiments of a method 450 for wireless communication. The method 450 may be performed by either a wireless communication node (e.g., gNB). The method 450 may include a portion or all of the following steps: step 460, determining a set of parameters of a configuration for a carrier in a cell, wherein the cell comprises a plurality of carriers; and/or step 470, sending the configuration comprising scheduling information for the carrier.

In some implementations, the scheduling cell and the scheduled cell are a same cell.

In some implementations, the scheduling cell and the scheduled cell are different cells.

In some implementations, the configuration comprises a serving-cell configuration; and/or the serving-cell configuration comprises at least one of the following: in response to the cell being a scheduling cell, a scheduling carrier index of the scheduling carrier, and/or in response to the cell being a scheduled cell, a scheduling cell index of the scheduling cell and the scheduling carrier index of the scheduling carrier.

In some implementations, in response to the cell being the scheduling cell, the scheduling carrier index indicates that one carrier based on the scheduling carrier index in the scheduling cell is configured as a scheduling carrier and being used to schedule other carrier; and/or in response to the cell being the scheduled cell, the scheduling cell index and the scheduling carrier index indicates that each carrier in the scheduled cell is configured as a scheduled carrier that is scheduled by another carrier based on the scheduling cell index and the scheduling carrier index.

In some implementations, the configuration comprises a serving-cell configuration; and
the serving-cell configuration comprises at least one of the following: in response to the carrier being a scheduling carrier, an information element indicating it being a scheduling carrier, and/or in response to the carrier being a scheduled carrier, the information element indicating it being a scheduled carrier, a scheduling cell index of the scheduling cell, and a scheduling carrier index of the scheduling carrier.

In some implementations, in response to the carrier being the scheduling carrier, the information element indicates that the scheduling carrier is configured as a scheduling carrier and being used to schedule other carrier; and/or in response to the carrier being the scheduled carrier, the information element indicates that the scheduled carrier is scheduled by another carrier based on the scheduling cell index and the scheduling carrier index.

In some implementations, the configuration comprises a serving-cell configuration comprising a downlink configuration list; and/or each downlink configuration corresponding to a downlink carrier comprises at least one of the following: in response to the downlink carrier being a scheduling carrier, an information element indicating it being a scheduling carrier, and/or in response to the downlink carrier being a scheduled carrier, the information element indicating it being a scheduled carrier, a scheduling cell index of the scheduling cell, and a scheduling carrier index of the scheduling carrier.

In some implementations, in response to the downlink carrier being the scheduling carrier, the information element indicates that the scheduling carrier is configured as a scheduling carrier and being used to schedule other carrier; and/or in response to the downlink carrier being the scheduled carrier, the information element indicates that the scheduled carrier is scheduled by another carrier based on the scheduling cell index and the scheduling carrier index.

In some implementations, carrier indexes for at least one downlink carrier and at least one uplink carrier are configured independently by at least one of the following: configuring a carrier index for the downlink carrier, and/or configuring a carrier index for the uplink carrier.

In some implementations, at least on downlink carrier is the anchor carrier; and/or the carrier index for the anchor downlink carrier further comprises at least one of the following: the smallest index, or a default index. In some implementations, the default index may have a value of 0.

In some implementations, the downlink configuration comprises at least one of the following: PDCCH configuration setup release information element; PDSCH configuration setup release information element; and/or CSI-measurement configuration setup release information element.

In some implementations, for multi-carrier scheduling, determining one of the following: a maximum number of co-scheduled carriers, a maximum number of co-scheduled cells comprising co-scheduled carriers, and/or the maximum number of co-scheduled carriers and the maximum number of co-scheduled cells.

In some implementations, the step of determining the maximum number of co-scheduled carriers comprises at least one of the following: determining the maximum number of co-scheduled carriers in one cell, and/or determining the maximum number of co-scheduled carriers in a plurality of cells.

In some implementations, for multi-carrier scheduling, control channel is located on at least one of the following: only one carrier of a cell with multiple carriers, or more than one carrier of a cell comprising multiple carrier.

In some implementations, the control channel is located on more than one carrier of the cell comprising multiple carrier, the control channel monitoring on one carrier at a time by: switching the more than one carrier for the control channel monitoring by a dynamic indication or a pre-configured pattern.

In some implementations, the control channel is located on more than one carrier of the cell comprising multiple carrier, the control channel monitoring the same carriers with a blind decoding (BD) or a control channel element (CCE) scaling factor for the carriers of the cell.

In some implementations, a size budget is determined according to at least one of the following: the size budget per carrier being equal to a pre-defined size budget per cell, the size budget for all carriers per cell being equal to the pre-defined size budget per cell, and/or the size budget for all carriers per cell being equal to or larger than the pre-defined size budget per cell, and being equal to or small than N times the pre-defined size budget per cell, wherein N is one of a number of carriers in one cell, a maximum number in one cell, or a value configured by a RRC signaling.

In some implementations, the size budget comprises at least one of the following: a BD size budget, a CCE size budget, or a DCI size budget.

In some implementations, a BD size budget, a CCE size budget, and a DCI size budget are determined according to at least one of the following: the DCI size budget per carrier being equal to a pre-defined DCI size budget per cell, and the BD size budget and the CCE size budget for all carriers per cell being equal to a pre-defined BD size budget and a pre-defined CCE size budget per cell, respectively, and/or the BD size budget and the CCE size budget per carrier being equal to a pre-defined BD size budget and a pre-defined CCE size budget per cell, respectively, and the DCI size budget for all carriers per cell being equal to a pre-defined DCI size budget per cell.

In some implementations, for multi-cell scheduling downlink control information (MC-DCI), a DCI size budget, a BD size budget, and a CCE size budget of the MC-DCI is counted according to at least one of the following: counted on one cell, and the DCI size budget, the BD size budget, and the CCE size budget for all carriers in one cell being equal to a pre-defined DCI, BD, and CCE size budget per cell, respectively, counted on one carrier, and the DCI size budget, the BD size budget, and the CCE size budget per carrier being equal to a pre-defined DCI, BD, and CCE size budget per cell, respectively, counted on one carrier or one cell, and the DCI size budget per carrier being equal to a pre-defined DCI size budget per cell, and determining the BD size budget and the CCE size budget for all carriers per cell being equal to a pre-defined BD size budget and a pre-defined CCE size budget per cell, respectively, or counted on one carrier or one cell, and the BD size budget and the CCE size budget per carrier being equal to a pre-defined BD size budget and a pre-defined CCE size budget per cell, respectively, and determining the DCI size budget for all carriers per cell being equal to a pre-defined DCI size budget per cell.

In some implementations, for multi-cell scheduling downlink control information (MC-DCI), a search space of the MC-DCI is configured according to at least one of the following: on each cell and each or a subset of carrier in the cell with a plurality of carriers, on a subset of cells and each or a subset of carrier in the cell with a plurality of carriers, on one cell and each or a subset of carrier in the cell with a plurality of carriers, or on one cell and one carrier in the cell with a plurality of carriers.

In some implementations, a value used in a search space equation for configuring the search space of the MC-DCI is determined at least one of the following: based on a cell index and a carrier index, or based on a configured value for a cell in response to the cell comprises a set of carriers, wherein the configured value is different from a carrier indicator filed (CIF) of the cell.

In some implementations, for a plurality of data channel transmission on a cell with a plurality of carriers, at least one start and length indicator value (SLIV) of the plurality of data channel transmission is combined with a carrier index to indicate the carrier for data channel transmission.

In some implementations, for a plurality of data channel transmission on a cell with a plurality of carriers, repetition with hopping among a plurality of carriers is configured.

In some implementations, for a cell with a plurality of carriers scheduled by a downlink control information (DCI), the DCI comprises at least one of the following: an indicator indicating carrier addition, release, activation, or deactivation; the indicator indicating uplink only secondary cell (SCell) addition, release, activation, or deactivation; each bit of SCell dormancy indication representing at least one cell with all carriers, at least one carrier with paired downlink-uplink carriers, at least one downlink carrier, or at least one uplink carrier; each bit of carrier dormancy indication representing at least one cell with all carriers, at least one carrier with paired downlink-uplink carriers, at least one downlink carrier, or at least one uplink carrier; or control channel monitoring adaptation indication applying on all carriers or combining with carrier adaptation indication in response to control channel monitoring on more than one carrier.

In some implementations, the indicator comprises at least one of the following: a carrier indicator or a bandwidth part (BWP) indicator.

In some implementations, the control channel comprising PDCCH, and/or data channel comprising at least one of the following: PDSCH or PUSCH.

### Embodiment Set I

The present disclosure describes various embodiments, wherein, when multiple carriers in one cell is supported, PDSCH/PUSCH on each carrier may be scheduled by self-carrier scheduling, cross carrier scheduling, multi-carrier scheduling.

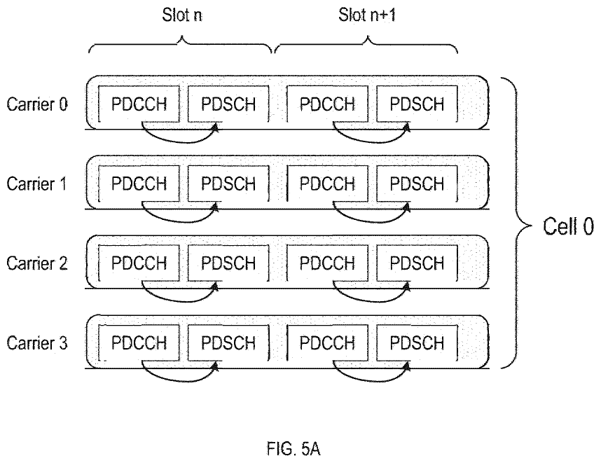

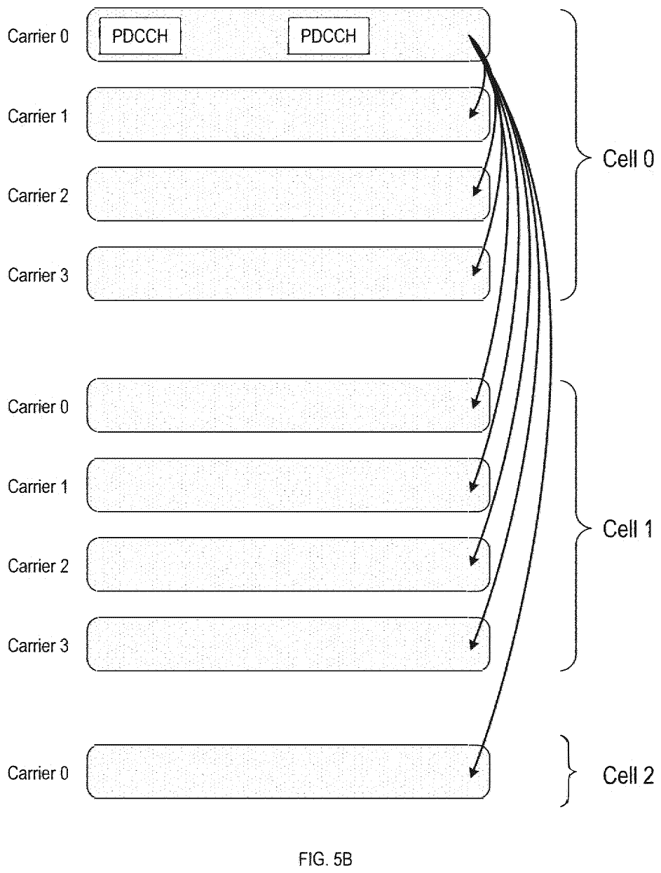

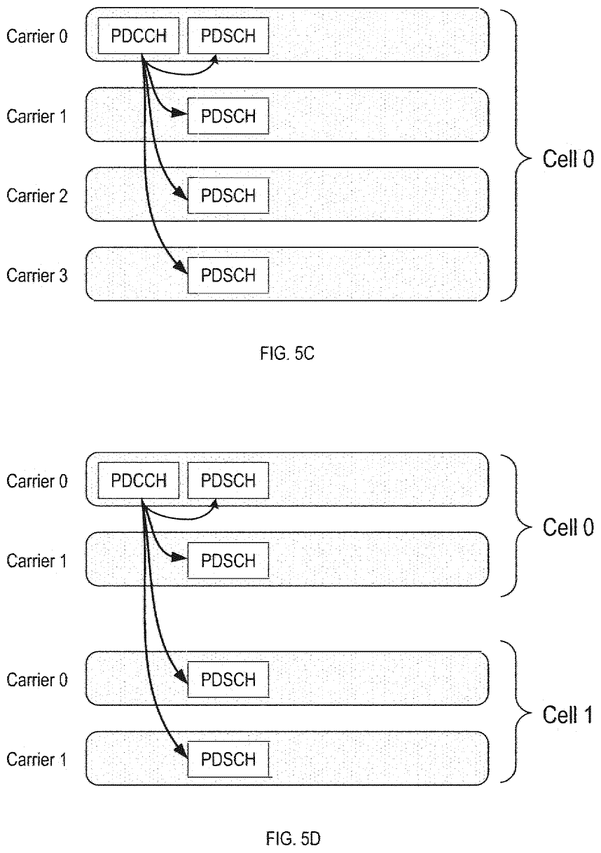

For self-carrier scheduling, as shown in FIG. 5A, each carrier may be self-scheduled. This is simpler for the scheduler, especially when the SCS of the multi-carrier are different. No need to consider issues of cross carrier scheduling within one cell or across cells.

For cross carrier scheduling, as shown in FIG. 5B, the carrier without PDCCH may be cross carrier scheduled by other carrier. Cell index and carrier index may be both used to schedule one carrier.

For multi-carrier scheduling, as shown in FIG. 5C and FIG. 5D, the carrier without PDCCH can be cross carrier scheduled by other carrier and multi-carrier can be scheduled by a single MC-DCI.

Various embodiments describe methods for determining association of scheduling carrier and scheduled carrier in same/different cell(s).

Method 1: Configured within ServingCellConfig, and all carriers within the cell will be configured as scheduled carrier or one carrier within the cell may be configured as scheduling carrier. Carrier index may be used for the configuration. For example, one cell with multiple carriers may be configured as own with the scheduling carrier index and can be used to scheduling other carriers. One cell with multiple carriers may be configured as other and may be configured with scheduling cell index and scheduling carrier index.

The ServingCellConfig may include a CrossCarrierSchedulingConfig information element (IE) as below.

| CrossCarrierSchedulingConfig ::= | SEQUENCE { |
|---|---|
| schedulingCarrierInfo CHOICE { | |
| own SEQUENCE { | |
| cif-Presence BOOLEAN | |
| carrierIndex CarrierIndex, | |
| }, | |
| other SEQUENCE { | |
| schedulingCellId | ServCellIndex, |
| schedulingCarrierId | CarrierIndex, |
| cif-InSchedulingCell | INTEGER (1..7) |

```
    }
  },
  ...
}
```

Method 2: Configured within ServingCellConfig and each carrier will be configured with scheduling information. Carrier index may be used for the configuration. For example, scheduling carrier in one cell will be configured as own and may be used to scheduling other carriers. Scheduled carrier in one cell will be configured as other and may be configured with scheduling cell index and scheduling carrier index.

The ServingCellConfig may include a CrossCarrierSchedulingConfig information element (IE) as below.

| | |
|---|---|
| CrossCarrierSchedulingConfig ::= | SEQUENCE { |

```
  CarrierToAddModList SEQUENCE (SIZE (1..N)) OF Carrier
  CarrierToReleaseList SEQUENCE (SIZE (1..N)) OF CarrierIndex
}
Carrier ::= SEQUENCE {
  Carrier CarrierIndex,
  schedulingCarrierInfo CHOICE {
      own SEQUENCE {
      cif-Presence BOOLEAN
    },
    other SEQUENCE {
```

| | |
|---|---|
| schedulingCellId | ServCellIndex, |
| schedulingCarrierId | CarrierIndex, |
| cif-InSchedulingCell | INTEGER (1..7) |

```
    }
  },
  ...
}
```

Method 3: Configured within DownlinkConfig. Wherein the DownlinkConfig is configured for each DL carrier. At least one of following configuration IE may be also configured within DownlinkConfig: pdcch-CarrierConfig SetupRelease {PDCCH-CarrierConfig}; pdsch-CarrierConfig SetupRelease {PDSCH-CarrierConfig}; esi-MeasConfig SetupRelease {CSI-MeasConfig}; and/or crossCarrierSchedulingConfig CrossCarrierSchedulingConfig.

For example, DL carrier, UL carrier, or the carrier including both DL carrier and UL carrier may be configured within ServingCellConfig. For each DL carrier, CrossCarrierSchedulingConfig may be configured for the carrier to be as own or other, and may be configured with scheduling cell index and scheduling carrier index.

The ServingCellConfig may include a DownlinkConfig information element (IE), as below.

| ServingCellConfig ::= SEQUENCE { | |
|---|---|
| DLCarrierToAddModList SEQUENCE(SIZE (1..N)) OF | |
| DownlinkConfig | |
| DLCarrierToReleaseList SEQUENCE(SIZE (1..N)) OF | |
| DownlinkCarrierIndex | |
| ... | |
| } | |
| DownlinkConfig ::= SEQUENCE { | |
| downlinkCarrierIndex DownlinkCarrierIndex, | |
| crossCarrierSchedulingConfig CrossCarrierSchedulingConfig | |
| ... | |
| } | |
| CrossCarrierSchedulingConfig ::= | SEQUENCE { |
| schedulingCarrierInfo CHOICE { | |
| own SEQUENCE { | |
| cif-Presence BOOLEAN | |
| }, | |
| other SEQUENCE { | |
| schedulingCellId | ServCellIndex, |
| schedulingCarrierId | CarrierIndex, |
| cif-InSchedulingCell | INTEGER (1..7) |

```
    }
  },
  ...
}
```

Various embodiments describe methods for determining association of DL carrier and UL carrier in one cell.

Method 1: One carrier index is shared for one DL carrier and its associated UL carrier. Optionally, one carrier index is only configured with DL carrier, or is only configured with UL carrier. The anchor carrier is configured explicitly, or smallest index, i.e. index 0 by default.

Method 2: One carrier index is shared for one DL carrier and its associated multiple UL carriers. Optionally, one carrier index is shared for one UL carrier and its associated multiple DL carriers. Optionally, one carrier index is only configured with DL carrier, or is only configured with UL carrier. The anchor carrier is configured explicitly, or smallest index, i.e. index 0 by default.

Method 3: Carrier index for DL carrier and UL carrier is configured independently. Optionally, the anchor DL and/or UL carrier is configured explicitly, or smallest index, i.e. index 0 by default. Optionally, based on method 3, association of scheduling carrier and scheduled carrier in same/different cell(s) can be configured for DL carrier and UL carrier independently.

There may be various benefits associated with various embodiments. In some embodiments, when multi-carrier are supported in one cell, several scheduling mechanisms are disclosed; and based on the potential scheduling mechanisms, the methods of association of scheduling carrier and scheduled carrier, the association of DL carrier and UL carrier are disclosed. It is benefit for network or UE to support this function with flexible scheduling mechanism.

### Embodiment Set II

The present disclosure describes various embodiments, wherein, for multi-carrier scheduling, the maximum number of co-scheduled carriers need to be determined to maintain a reasonable DCI size of a MC-DCI format. The maximum number of co-scheduled carriers can be determined by one of following.

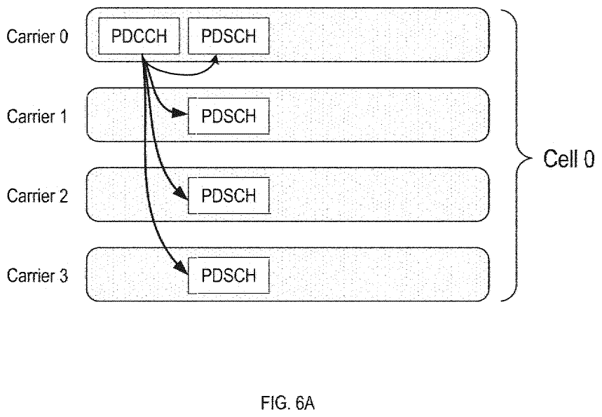

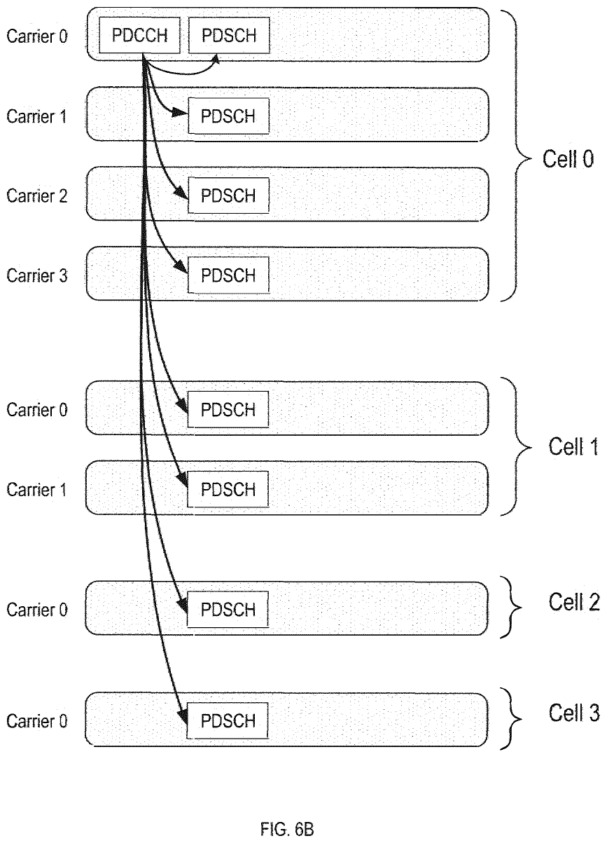

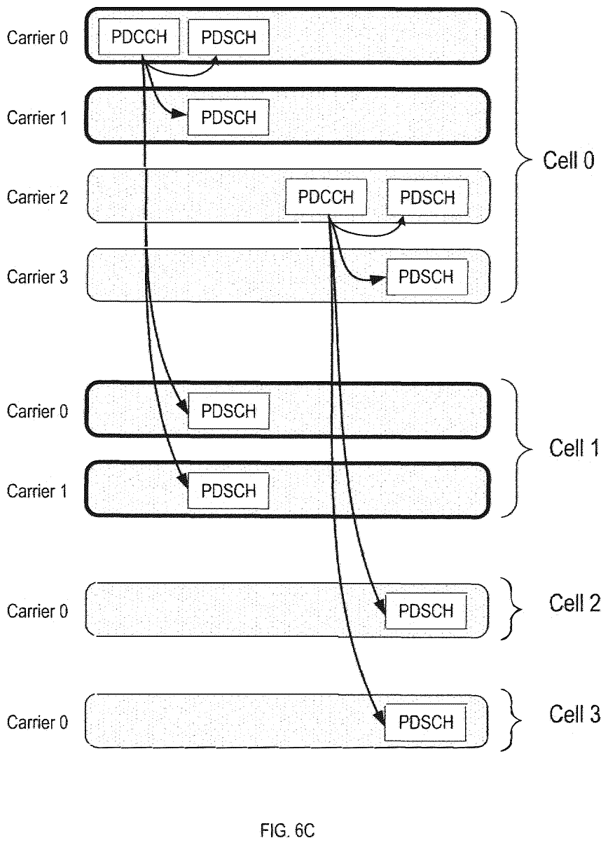

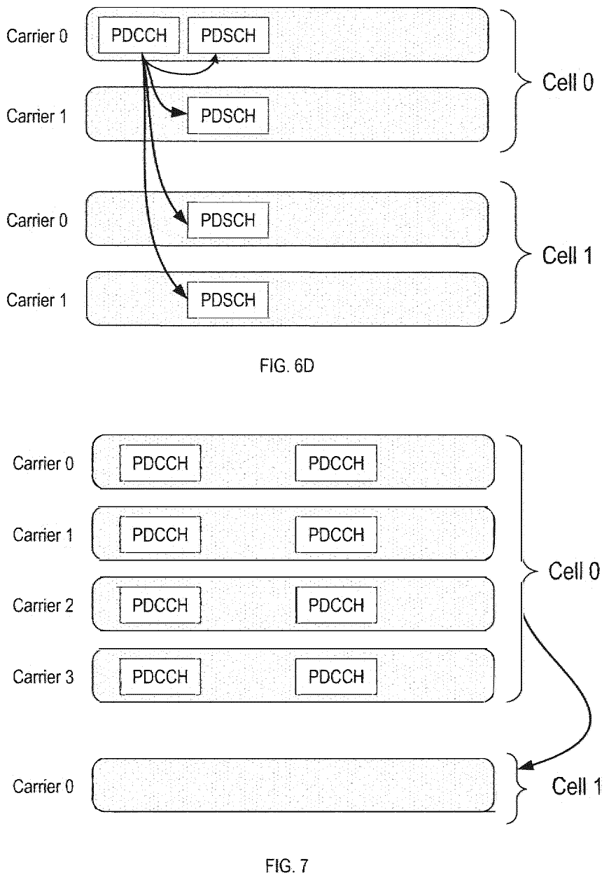

One method for defining the maximum number of co-scheduled carriers: The maximum number may be defined as an integer N, e.g., N=4. Optionally, the multiple carriers in one cell may be included in one set of carriers. For example as shown in FIG. 6A, cell 0 comprises four carriers, and the four carriers are in the one set of carriers and can be scheduled by one MC-DCI.

Another method for define the maximum number of co-scheduled cells: The maximum number may be defined as an integer N, e.g., N=4. That is, the maximum number of carriers depends on the carriers in each cell. Optionally, the fields of MC-DCI format for each cell are shared for each carrier in the same cell. Optionally, the multiple carriers in one cell may be included in one set of carriers. For example as shown in FIG. 6B, cell 0 comprises four carriers, cell 1 comprises two carriers, cell 2 comprises one carrier, and cell 3 comprises one carrier, the maximum number of cells is 4 and all the carriers within the four cells, that is 8 carriers, can be scheduled by one MC-DCI.

Another method for defining the maximum number of co-scheduled carriers: The maximum number may be defined as an integer N, e.g., N=4. Optionally, different carriers in one cell may be comprised in different sets of carriers. It is benefit for using same scheduling cell while load balance for PDCCH on different carriers in one cell. For example as shown in FIG. 6C, cell 0 comprises four carriers, cell 1 comprises two carriers, cell 2 comprises one carrier, cell 3 comprises one carrier, the maximum number of carriers is 4 and different carriers in one cell can be comprised in different sets of carriers. In some implementations, carrier 0 and 1 in cell 0 and two carriers in cell 1 are in one set and can be scheduled by one MC-DCI on carrier 0 in cell 0; and carrier 2 and 3 in cell 0, one carrier in cell 2 and one carrier in cell 3 are in another set and can be scheduled by one MC-DCI on carrier 2 in cell 0. In FIG. 6C, the carriers with thicker lines are in set 0, and the carrier with thinner lines are in set 1.

Another method for defining the maximum number of co-scheduled carriers and the maximum number of co-scheduled cells. In some implementations, the maximum number are {N,M} for { maximum number of co-scheduled carriers, the maximum number of co-scheduled cells} respectively, e.g. {N=4, M=2}. Optionally, the multiple carriers in one cell may be included in one set of carriers. Optionally, different carriers in one cell can be comprised in different sets of carriers. It is benefit for using same scheduling cell while load balance for PDCCH on different carriers in one cell. For example as shown in FIG. 6D, cell 0 comprises two carriers, cell 1 comprises two carriers, the maximum number of co-scheduled carriers is 4 and the maximum number of co-scheduled cells is 2. Multiple carriers in one cell are comprised in one set of carriers, that is two carriers in cell 0 and two carriers in cell 1 are in one set and can be scheduled by one MC-DCI on carrier 0 in cell 0.

In various embodiments, at least one of the following are defined: the max number of carriers of one set of carriers, or max number of cells of one set of cells, or max number of cells and max number of carriers for the multi-carrier scheduling. Optionally, multi-carrier in one cell are included in one or different set of cells/carriers.

In some implementations, alternatively, the co-scheduled carriers within a set of carriers may be configured by higher layer parameter, and cell index and carrier index are used to configure the code-point table. Taking FIG. 6D as an example, the co-scheduled carriers table can be shown as Table 3.

TABLE 3
Co-scheduled carriers table

| Co-scheduled | |
|---|---|
| carriers index | cell index and carrier index |
| 00 | cell 0 carrier 0 |
| 01 | cell 0 carrier 0, cell 0 carrier 1 |
| 10 | cell 1 carrier 0, cell 1 carrier 1 |
| 11 | cell 0 carrier 0, cell 0 carrier 1, |
| | cell 1 carrier 0, cell 1 carrier 1 |

There are various benefits associated with the described embodiments. For example, when multi-carrier is supported in one cell and multi-carrier scheduling is also supported, the maximum number of co-scheduled carriers can be defined by the max number of carriers of one set of carriers, or max number of cells of one set of cells, or max number of cells and max number of carriers for the multi-carrier scheduling. It is benefit for network or UE to achieve control overhead reduction or load balance.

### Embodiment Set III

The present disclosure describes various embodiments, wherein, for cross carrier scheduling with or without multi-carrier scheduling, cell index and carrier index are used to schedule one carrier. In some implementations, when the cell with multi-carrier is scheduled by other carrier/cell, there are no PDCCH on either carrier of the cell. The scheduling carrier/cell can be determined by association of scheduling carrier and scheduled carrier in same/different cell(s). In some implementations, when the cell with multi-carrier is a scheduling cell and optionally can be used to schedule other cells, the PDCCH monitoring for a scheduled carrier/cell can be located in one of following methods.

For one method, there is only one carrier of the cell with multi-carrier. In order to better support PDSCH/PUSCH simultaneously transmission on multi-carrier in one cell, CCE resources may be determined by cell index and carrier index of the scheduled carrier, or an extend carrier indicator filed (CIF). For example, N*n_CI+n_carrier may be used instead of n_CI, wherein n_CI is the carrier indicator field value when the UE is configured with a carrier indicator field by CrossCarrierSchedulingConfig for the serving cell on which PDCCH is monitored; and N is the maximum number of carriers in one cell. In some implementations, when using extended CIF, the value of extended CIF may be larger than 7, and CIF may be configured for each carrier, or each DL carrier or each UL carrier. When only single cell with multiple carriers is supported or configured, carrier index instead of cell index may be used.

For another method, there may be more than one carrier of the cell with multi-carrier and PDCCH monitoring on one carrier at a time. In some implementations, PDCCH monitoring on one carrier at a time can be determined by one of following.
(1) Switching the carrier for PDCCH monitoring by signalling, for example, switching the carrier of the candidate carriers configured with PDCCH for monitoring for a scheduled carrier/cell by DCI or MAC CE or RRC. For example, as shown in FIG. 7, cell 1 is scheduled by cell 0, and four carriers in cell 0 are configured with PDCCH. a field in a DCI format may be used to switch the carrier for PDCCH monitoring only on one carrier at a time, so the field may be 2 bits, “00” represents carrier 0, “01” represents carrier 1, “10” represents carrier 2, “11” represents carrier 3, monitoring on carrier 0 when no indication or monitoring on one carrier by RRC configuration.
(2) Configuring PDCCH monitoring pattern for a scheduled carrier/cell. For example, bitmap within a period may be used to indicate PDCCH monitoring on each slot (or subslot) or on N slots based on a reference carrier, wherein N is an integer. The reference carrier may be the carrier with lowest index or the carrier with lowest SCS among the candidate carriers or the carrier configured by RRC, i.e. carrier 0 within the cell, or carrier with 15 khz. For example, as shown in FIG. 7, cell 1 is scheduled by cell 0 and four carriers in cell 0 are configured with PDCCH, and PDCCH monitoring pattern is configured to ensure the PDCCH monitoring only on one carrier at a time, the pattern may be configured within a period equal to one frame for each slot, and the reference carrier is carrier 0 with SCS=15 khz. Each slot may use 2 bits to indicate one carrier, for example, “00” represents carrier 0, “01” represents carrier 1, “10” represents carrier 2, “11” represents carrier 3. In the example, the bitmap pattern may be “00000000000101111010” for 10 slots in a frame.

For another method, there may be more than one carrier of the cell with multi-carrier and PDCCH monitoring with BD/CCE scaling factor. In some implementations, BD/CCE scaling factor of each scheduling carrier for a scheduled cell is configured. In some implementations, legacy BD/CCE budget/capability is maintained. For example, as shown in FIG. 7, α1, α2, α3, and α4 may be configured for each scheduling carrier to scaled the legacy BD/CCE for scheduling the same scheduled carrier/cell. In some implementations, α1+α2+α3+α4=1. For example, when the SCS of carrier 0, 1, 2, and 3 in cell 0 are all 15 khz, and α1=α2=α3=α4=0.25, a maximum BD for a scheduled cell is 44*0.25+44*0.25+44*0.25+44*0.25=44, so that there are up to 11 BDs for PDCCH monitoring on each carrier in cell 0 for the scheduled cell 1.

In some implementations, for CA scaling, split factors s1, s2, s3, and s4 can be also defined/configured for each scheduling carrier to schedule a same scheduled carrier. In some implementations, s1+s2+s3+s4=1. For example, there are 5 carriers for CA operation in FIG. 7, Ncap=4, the SCS of carrier 0, 1, 2, and 3 in cell 0 and carrier 0 in cell 1 are 15 khz, 15 khz, 30 khz, 30 khz, and 30 khz, respectively; and s1=s2=s3=s4=0.25 for a scheduled carrier to be counted in each scheduling carrier which is similar as N_cell number, M_total_15 khz=floor(4*44*[1+1+0.25+0.25]/5)=floor(4*44*1/2)=88 per Ims slot; M_total_30 khz=floor(4*36*[1+1+0.25+0.25]/5)=floor(4*36*1/2)=72 per 0.5 ms slot. The carrier number is used for CA scaling in the example, and other methods as described in other embodiments may be used as well.

There are various benefits associated the embodiments. For example, when multi-carrier are supported in one cell and cross carrier scheduling is also supported, the PDCCH monitoring for a scheduled carrier/cell can be located in one or more carriers within the cell with multiple carriers. It is benefit for network or UE to achieve same PDCCH monitoring capability even with PDCCH load balance.

### Embodiment Set IV

The present disclosure describes various embodiments, wherein, when multiple carriers in one cell is supported, PDSCH/PUSCH on each carrier can be scheduled by self-carrier scheduling, cross carrier scheduling, and/or multi-carrier scheduling. The BD/CCE/DCI size budget may be determined by per carrier and/or per cell and one of following methods can be used to determine the BD/CCE/DCI size budget in case multiple carriers in one cell is supported.

A first method including setting the BD/CCE/DCI size budget per carrier being equal to legacy per cell budget. In some implementations, the processing capability for one carrier is same/similar as one cell in legacy CA framework. In some implementations, the M/C_max is defined per carrier instead of per cell. For example,

$${M}_{PDCCH}^{max , slot , μ}$$

is represented as maximum number of monitored PDCCH candidates per slot and per carrier. In some implementations, the M/C_total is still applied for each SCS, while the number of DL carriers is used in M/C_total calculation, that is changing the number of DL cells to the number of DL carriers, as below.

$${\sum }_{Ncell \_i = 0}^{N 1} ( Ncell\_i \cdot {\sum }_{Ncarrier \_ j = 0}^{N 2 \_ in \_ Ncell \_ i} Ncarrier\_j ) .$$

For example,

$${M}_{PDCCH}^{total , slot , μ} = ⌊ {N}_{cells}^{cap} \cdot {M}_{PDCCH}^{max , slot , μ} \cdot {N}_{carriers}^{DL , μ} / {\sum }_{j = 0}^{3} {N}_{carriers}^{DL , j} ⌋ .$$

In some implementations, the DCI size budget per carrier is defined instead of per cell. For example, UE is not expected to handle the total number of different DCI sizes configured to monitor is more than 4 for a carrier or DL carrier; or the total number of different DCI sizes with C-RNTI configured to monitor is more than 3 for the carrier or DL carrier.

A second method including setting the DCI size budget per carrier being equal to legacy per cell budget, and setting the BD/CCE budget for all the carriers in one cell being equal to legacy per cell budget. In some implementations, the processing capability of BD/CCE for all carriers is same/similar as one cell in legacy CA framework. While DCI size budget for one carrier is similar as one cell in current CA framework. This method may have the benefit because the multiple carriers in one cell are configured with different RRC parameters and the DCI size of a DCI format for different carriers are very different, while the PDCCH monitoring capability is restricted for a UE. In some implementations, the DCI size budget per carrier is defined to instead of per cell. For example, UE is not expected to handle the total number of different DCI sizes configured to monitor is more than 4 for a carrier or DL carrier; or the total number of different DCI sizes with C-RNTI configured to monitor is more than 3 for the carrier or DL carrier. In some implementations, shared BD/CCE budget for all carriers in one cell, BD/CCE scaling factor for multi-carrier in one cell are configured. For example, when four carriers in one cell is assumed, α1, α2, α3, α4 are configured for each carrier to scaled the legacy BD/CCE budget per cell, for example, α1+α2+α3+α4=1. For another example, when the SCS of the carrier 0, 1, 2, and 3 in one cell are all 15 khz, and α1=α2=α3=α4=0.25, maximum BD for each carrier is 44*0.25=11, so that there are up to 11 BDs for PDCCH monitoring for each carrier in cell 0.

A third method includes BD/CCE budget per carrier being equal to legacy per cell budget, while DCI size budget for all the carriers in one cell is equal to legacy per cell budget. This method is benefit for the multiple carriers in one cell being configured with same/similar RRC parameters and the DCI size of a DCI format for different carriers being same/similar. While the PDCCH monitoring capability for a carrier may be regarded as for a legacy cell. Optionally, the M/C_max per carrier is defined to instead of per cell. Optionally, the M/C_total is still applied for each SCS, while the number of DL carriers is used in M/C_total calculation, that is changing the number of DL cells to the number of DL carriers. Optionally, the DCI size budget for all carriers in one cell is same as legacy budget per cell. For example, UE is not expected to handle the total number of different DCI sizes configured to monitor being more than 4 for a cell; or the total number of different DCI sizes with C-RNTI configured to monitor being more than 3 for the cell. That is for a DCI format, DCI size is same for each carrier in the cell.

A fourth method includes BD/CCE/DCI size budget for all the carriers in one cell being equal to legacy per cell budget. Optionally, shared BD/CCE budget for all carriers in one cell, BD/CCE scaling factor for multi-carrier in one cell are configured. Optionally, the DCI size budget for all carriers in one cell is same as legacy budget per cell.

A fifth method includes BD/CCE/DCI size budget for all the carriers in one cell being no less than legacy per cell budget and no larger than N times of legacy per cell budget. Wherein, N is the number of carriers in one cell, or the max number of carriers in one cell, or a value configured by RRC parameter. Optionally, the detailed budget may be determined by a scaling factor based on the number of carriers, or configured by RRC parameter. For example, when assuming 4 carriers in one cell, BD/CCE budget for all the carriers in one cell is α×N, wherein N is the number of carriers in the cell, N=4, α=0.5 configured by RRC parameter, as a result, BD/CCE budget for all the carriers in one cell is 2 times of legacy per cell budget.

In various embodiments, a number of search space per carrier and/or a number of CORESET per carrier may be determined by one of following methods.

One method includes being same as legacy budget per BWP and optionally when the max number of carriers in one cell is not larger than 4. For example, assuming that one cell comprises 4 carriers, there are up to 10 search spaces per carrier and up to 3 CORESETs per carrier.

Another method includes being same as legacy budget per cell. For example, assuming that one cell comprises 4 carriers, there are up to 40 search spaces per carrier and up to 12 CORESETs per carrier.

Another method includes Redefining/scaling based on legacy budget per cell and optionally when the max number of carriers in one cell is more than 4. Optionally, the scaling factor is derived based on the number of carriers in one cell, i.e. 1/(the number of carriers in one cell), or configured by RRC configuration. For example, assume one cell comprise 8 carriers, there are up to α×40 search spaces per carrier and up to β×12 CORESETs per carrier. i.e., α=⅛, β=⅙.

In some implementations, optionally, PUCCH can be only configured in one carrier of the cell with multi-carrier. Carrier index order in one cell may be added in HARQ-ACK codebook constructed. Optionally, when PUCCH carrier/cell switching is supported, more than one carrier in one cell and optionally combined with other carrier in SCell can be configured, while only one carrier is used at a time. For example, both carrier index and cell index may involve in the semi-static pattern or dynamic indication.

There may be various benefits associated with the embodiments. For example, when multi-carrier are supported in one cell and PDSCH/PUSCH on each carrier can be scheduled by self-carrier scheduling, cross carrier scheduling, multi-carrier scheduling, BD/CCE/DCI size budget may be determined by per carrier and/or per cell based on legacy per cell budget w/o extended. It is benefit for network or UE to achieve same or different PDCCH monitoring capability for multiple carriers in one cell.

### Embodiment Set V

The present disclosure describes various embodiments, wherein, when multiple carriers in one cell is supported and multi-carrier scheduling is supported, the embodiments address a portion or all of the following: how to count the DCI size and BD/CCE of MC-DCI, and how to configure the search space with MC-DCI.

In some implementations, in legacy multi-cell scheduling, DCI size and BD/CCE of the MC-DCI is counted on one cell among the set of cells. The search space of the MC-DCI is configured on the cell among the set of cells. For monitoring PDCCH candidates for a set of cells which is configured for multi-cell scheduling, the n_CI in the search space equation is determined by a value configured for the set of cells by RRC signaling.

In some implementations, DCI size and BD/CCE of the MC-DCI is counted by one of following: counted on one cell and BD/CCE/DCI size budget for all the carriers in one cell is equal to legacy per cell budget; or counted on one carrier and BD/CCE/DCI size budget per carrier is equal to legacy per cell budget, or DCI size and BD/CCE can be counted on different reference carrier or cell, and one of BD/CCE budget and DCI size budget is per cell, the other is per carrier.

In some implementations, search space of the MC-DCI is configured by one of following: configured on each cell and each/subset/one carrier of the cell with multi-carrier; configured on subset of the set of cells and each/subset/one carrier of the cell with multi-carrier; configured on one cell of the set of cells and each/subset carrier of the cell with multi-carrier. Optionally PDCCH monitoring for a scheduled carrier/cell can be located on more than one carrier of the cell with multi-carrier; or configured on one cell of the set of cells and one carrier of the cell with multi-carrier. Optionally PDCCH monitoring for a scheduled carrier/cell is located on one carrier of the cell with multi-carrier.

In some implementations, n_CI in the search space equation is determined by one of following methods.

A first method includes that the n_CI in the search space equation is determined by a value configured for the set of cells and there are more than one cell are included in the set with at least one cell with multi-carrier.

A second method includes the n_CI in the search space equation being determined by cell index and carrier index, or extend CIF. For example, using N*n_CI+n_carrier to instead of n_CI, wherein n_CI is the carrier indicator field value if the UE is configured with a carrier indicator field by CrossCarrierSchedulingConfig for the serving cell on which PDCCH is monitored. Wherein, N is the maximum number of carriers in one cell. In some implementations, extended CIF may be used, the value of extended CIF could be larger than 7, and/or CIF may be configured for each carrier, or each DL carrier or each UL carrier. When only single cell with multiple carriers is supported or configured, carrier index instead of cell index may be used.

A third method includes another configured value for a cell when the set of carriers are all included in the cell. Optionally for this method, only single cell with multiple carriers is supported or configured with multi-carrier scheduling.

There may be various benefits associated with the embodiments. For example, when multi-carrier are supported in one cell and PDSCH/PUSCH on each carrier can be scheduled by self-carrier scheduling, cross carrier scheduling, multi-carrier scheduling, search space of MC-DCI is configured on, or BD/CCE/DCI size of the MC-DCI is counted on one cell and one/sub-set/each carrier of the cell. It is benefit for network or UE to achieve same PDCCH monitoring capability or PDCCH load balance.

### Embodiment Set VI

The present disclosure describes various embodiments, wherein, when multiple carriers in one cell is supported and multiple transmission time interval (multi-TTI) scheduling or repetition is supported, the embodiments address how to perform the multi-TTI scheduling or repetition. In the present disclosure, multi-TTI scheduling may refer to multi-PDSCH/PUSCH scheduling on same cell. The embodiments may include one of the following methods.

A first method includes single carrier transmission combined with multi-TTI transmission. Optionally, the multi-TTI transmission may be only on same single carrier within the cell. Optionally, the multi-TTI transmission may be on multiple carrier within the cell and on one carrier at a time. That is, when configuring the TDRA table, each or several SLIV of the multi-PDSCH/PUSCH may be combined with carrier index to indicate the carrier for each PDSCH/PUSCH.

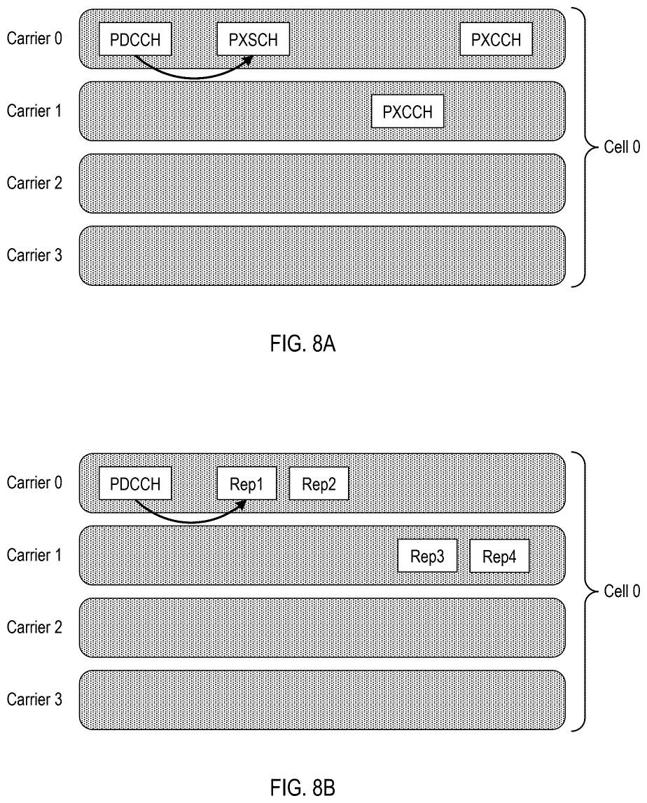

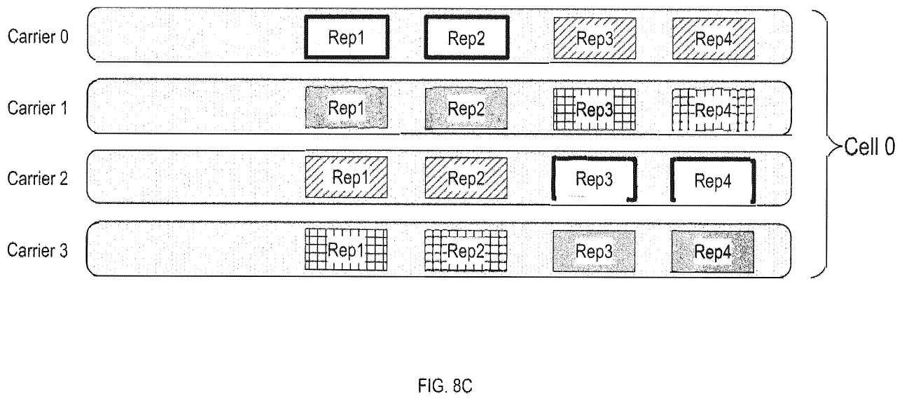

For an example, as shown in FIG. 8A, PXSCH may include PUSCH or PDSCH, cell 0 comprises 4 carriers, the multi-PUSCH is also supported, and for the TDRA table, at least one row includes multiple SLIVs for PUSCH, and each SLIV may also be configured with carrier index. As a detailed example of RRC parameter, a UE is configured with higher layer parameter pusch-TimeDomainAllocationListForMultiPUSCH in which one or more rows contain multiple SLIVs for PUSCH on a UL BWP of a serving cell, and the UE does not expect to be configured with numberOfRepetitions in pusch-TimeDomainAllocationListForMultiPUSCH. For one row with 4 SLIVs, the first, second and fourth SLIV will be configured with carrier index=0, and the third SLIV will configured with carrier index=1.

```
pusch-TimeDomainAllocationListForMultiPUSCH-r16 SetupRelease {
PUSCH-
TimeDomainResourceAllocationList-r16 }
PUSCH-Time DomainResourceAllocationList-r16 ::= SEQUENCE
(SIZE(1..maxNrofUL-Allocations-r16)) OF
PUSCH-TimeDomainResourceAllocation-r16
PUSCH-TimeDomainResourceAllocation-r16 ::= SEQUENCE {
  k2-r16 INTEGER(0..32) OPTIONAL, -- Need S
  puschAllocationList-r16 SEQUENCE
  (SIZE(1..maxNrofMultiplePUSCHs-r16)) OF PUSCH-Allocation-r16,
...
}
PUSCH-Allocation-r16 ::= SEQUENCE {
  mappingType-r16 ENUMERATED {typeA, typeB} OPTIONAL, --
  Cond NotFormat 01-02-Or-TypeA
  startSymbolAndLength-r16 INTEGER (0..127) OPTIONAL, -- Cond
  NotFormat 01-02-Or-TypeA
  carrierIndex INTEGER (0..maxNrofcarriers) OPTIONAL,
  startSymbol-r16 INTEGER (0..13) OPTIONAL, -- Cond RepTypeB
  length-r16 INTEGER (1..14) OPTIONAL, -- Cond RepTypeB
  numberOfRepetitions-r16 ENUMERATED {n1, n2, n3, n4, n7, n8,
  n12, n16} OPTIONAL, -- Cond
Format01-02
  ...,
  [[
  numberOfRepetitionsExt-r17 ENUMERATED {n1, n2, n3, n4, n7,
  n8, n12, n16, n20, n24, n28, n32,
spare4, spare3, spare2,
  spare1} OPTIONAL, -- Cond Format01-02-For-TypeA
  numberOfSlotsTBoMS-r17 ENUMERATED {n1, n2, n4, n8, spare4,
  spare3, spare2, spare1} OPTIONAL, --
Need R
  extendedK2-r17 INTEGER (0..128) OPTIONAL -- Cond MultiPUSCH
  ]]
}
```

A second method includes single carrier transmission combined with repetition transmission. Optionally, the repetition transmission may be only on same single carrier within the cell. Optionally, the repetition transmission on multiple carrier within the cell and on one carrier at a time. That is, besides the numberOfRepetitions configured in the TDRA table, each or several transmission of the repetition may be configured with carrier index to indicate the carrier for each transmission, or transmission/hopping pattern may be configured for the repetition.

For an example, as shown in FIG. 8B, the number of repetition for PUSCH or PDSCH transmission is 4, and cell 0 comprise 4 carriers. For the TDRA table, at least one row contain numberOfRepetitions=4, hopping pattern is configured within N carrier, i.e. N=2 for carrier 0/1, and hopping interval is also configured by higher layer parameter, i.e. numberOfRepetitions/2.

A third method includes multiple carriers transmission combined with multi-TTI/repetition transmission. Optionally, the repetition transmission on each carrier within the cell may be configured with a common hopping pattern based on the cell with multi-carrier.

For an example, as shown in FIG. 8C, the number of repetition for PUSCH or PDSCH transmission is 4, and cell 0 comprises 4 carriers. The common hopping pattern is configured for the cell with multi-carrier, i.e. hopping interval is configured with same value for the cell with multi-carrier by higher layer parameter, i.e. one of 2, 4, 5, 10 slot or subslot or a group of symbols based on a SCS. The carrier order for common hopping pattern may be also configured, e.g., configured with paired carriers pair (e.g., carrier 0 and 2 as a pair) and another pair (e.g., carrier 1 and 3 as a pair) within the cell. In some implementations, the carrier order for common hopping pattern can be defaulted by carrier index ascending order.

There may be various benefits associated with the embodiments. For example, when multi-carrier is supported in one cell and Multi-TTI/repetition transmission is also supported, the transmission across more than one carrier is disclosed with SLIV combined with carrier index or with hopping pattern among more than one carrier for the repetition. It is benefit for network or UE to avoid invalid symbols/slots or to achieve hopping gain among carriers.

### Embodiment Set VII

The present disclosure describes various embodiments, wherein, when multiple carriers in one cell is supported, PDSCH/PUSCH on each carrier can be scheduled by self-carrier scheduling, cross carrier scheduling, multi-carrier scheduling. Some DCI fields used for one cell scheduling or multi-cell scheduling may be reused or updated for scheduling the cell with multi-carrier.

In some implementations, SRS request may be extended to applied one or more carriers within one cell with type 1B. That is, a single field indicates separate information to each of co-scheduled carriers within the cell via joint indication. For example as shown in Table 4, when there are 3bits Type 1B for SRS request of 4 co-scheduled carriers in the cell, each row represents a state of a joint indication of all carriers within the cell.

TABLE 4
3 bits indicate SRS request

| index | carrier 0 | carrier 1 | carrier 2 | carrier 3 |
|---|---|---|---|---|
| 0 | SRS 0 | SRS 0 | SRS 0 | SRS 0 |
| 1 | SRS 1 | SRS 1 | SRS 1 | SRS 1 |
| 2 | SRS 2 | SRS 2 | SRS 2 | SRS 2 |
| 3 | SRS 3 | SRS 3 | SRS 3 | SRS 3 |
| 4 | SRS 0 | SRS 1 | SRS 2 | SRS 3 |
| 5 | SRS 1 | SRS 2 | SRS 3 | SRS 0 |
| 6 | SRS 2 | SRS 3 | SRS 0 | SRS 1 |
| 7 | SRS 3 | SRS 0 | SRS 1 | SRS 2 |

In Table 4, SRS 0/1/2/3 may refer to the value of 00/01/10/11, corresponding to No aperiodic SRS resource set triggered, SRS resource set(s) configured by SRS-ResourceSet with higher layer parameter aperiodicSRS-ResourceTrigger set to 1 or an entry in aperiodicSRS-ResourceTriggerList set to 1, 2, 3 respectively.

In some implementations, SRS request may be extended to applied only one carrier within one cell with type 1C. That is, a single field indicates an information to only one of co-scheduled carrier of the cell. For example, when there are 2 bits SRS request to indicate SRS 0/1/2/3, and 2 bits carrier indicator to apply the SRS transmission on one carrier of the 4 co-scheduled carriers in the cell.

In some implementations, rate matching indicator may be extended to applied for one or more carriers within one cell with type 1B. That is, a single field indicates separate information to each of co-scheduled carriers within the cell via joint indication. This may be similarly applied for ZP CSI-RS trigger.

In some implementations, SCell and/or carrier dormancy indication may be operated by cell level as legacy, or extended to applied one or sub-set carriers within a cell, and optionally the paired DL/UL carriers is configured/supported in the cell with multi-carrier. Optionally, this may be applied for DL carrier and UL carrier separately, which may mean that DL and UL carrier are decoupled, and DL carriers and UL carriers are configured independently and unpaired. For example, the field for SCell and/or carrier dormancy indication may use each bit to indicated one or a group of cells with all carriers, or one or a group of carriers with paired DL/UL carriers, or one or a group of DL carriers, or one or a group of UL carriers.

In some implementations, SCell and/or carrier dormancy indication are included in the multi-cell or multi-carrier scheduling DCI. Optionally, in case all the carriers or cells are scheduled without actual PDSCH or PUSCH which are based on invalid FDRA, that is all bits of frequency domain resource assignment for each carrier or cell are set to 0 for resource allocation type 0 or set to 1 for resource allocation type 1 or set to 0 or 1 for dynamic switch resource allocation type, the HARQ-ACK feedback for the (multi-cell scheduling downlink control information or multi-carrier scheduling downlink control information) MC-DCI used for dormancy indication is associated with the first sub-codebook. Optionally, in case at least one carrier or cell is scheduled with actual PDSCH or PUSCH which are based on valid FDRA, the HARQ-ACK feedback for the MC-DCI including dormancy indication is associated with the second sub-codebook. Optionally, for the second sub-codebook, the HARQ-ACK bits order is HARQ-ACK for the scheduled PDSCH first, then HARQ-ACK for the dormancy indication; or the HARQ-ACK bits order is HARQ-ACK for the dormancy indication first, then HARQ-ACK for the scheduled PDSCH; or the HARQ-ACK bits order is HARQ-ACK for the scheduled PDSCH and for the dormancy indication based on cell or carrier index with ascending or descending order co-scheduled by the MC-DCI. For Type-2 HARQ-ACK codebook, two sub-codebooks are generated with a first sub-codebook comprising HARQ-ACK information bits for PDSCH(s) scheduled by DCI(s) with each scheduling a single cell or carrier and a second sub-codebook comprising HARQ-ACK information bits for PDSCH(s) scheduled by DCI(s) with each scheduling more than one cell or carrier.

In some implementations, PDCCH monitoring adaptation indication may be applied on all carrier or combined with carrier adaptation indication in case PDCCH monitoring on more than one carrier. When only one carrier of the cell with multi-carrier is configured with PDCCH, PDCCH monitoring adaptation indication may be applied for the carrier of the cell. When more than one carrier within one cell are configured with PDCCH, for a UE only performs PDCCH monitoring only on one carrier at a time, then applied for only one carrier; for a UE performs PDCCH monitoring on more than one carrier, then applied on all carrier or combined with carrier adaptation indication. For example, besides pdcch-SkippingDurationList configured for time domain, a UE may be also configured with PDCCH skipping carrier pattern, i.e. a carrier order for PDCCH monitoring at a time and may be optionally combined with pdcch-SkippingDurationList.

In some implementations, a carrier indicator or BWP indicator may be used for carrier/UL only SCell adding/release. For example, BWP indicator can be reused for carrier index in case the number of carriers in one cell is not larger than 4 and more than one BWP can be indicated at a time. Optionally a pair or combination {Carrier index, BWP index} needs to be defined or configured, and the field is changed to Type 1B and only for multi-carrier (de)activation. For another example, carrier index is independent with BWP indicator, one carrier could be configured with one or more BWP, a carrier indicator is used for multi-carrier (de)activation, the BWP indicator is still Type 1A for all carriers.

In various embodiments, above methods may be also applied for UL only SCell (de)activation. It is benefit to avoid SCell (de)activation. Note, the carrier in the embodiments could be a paired DL/UL carrier, or a DL carrier, or a UL carrier.

There may be various benefits associated with the embodiments. For example, when multi-carrier are supported in one cell, some DCI fields used for one cell scheduling or multi-cell scheduling may be reused or updated for scheduling the cell with multi-carrier. It is benefit for network or UE to achieve control overhead reduction and less complexity.

The present disclosure describes various embodiments for scheduling mechanism with multi-carrier scheduling for multi-carrier in one cell.

In some embodiments, association of scheduling carrier and scheduled carrier in same/different cell(s) can be determined by one of the following methods. Method 1: Configured within ServingCellConfig, and all carriers within the cell may be configured as scheduled carrier or one carrier within the cell may be configured as scheduling carrier. Method 2: Configured within ServingCellConfig and each carrier may be configured with scheduling information. Method 3: Configured within DownlinkConfig, wherein the DownlinkConfig is configured for each DL carrier.

In some embodiments, carrier index for DL carrier and UL carrier is configured independently. the anchor DL and/or UL carrier is configured explicitly, or implicitly determined by smallest index by default.

Some embodiments include defining the max number of cells and max number of carriers for the multi-carrier scheduling. Optionally, multi-carrier in one cell are included in one or different set of cells/carriers. Optionally, the co-scheduled carriers within a set of carriers may be configured by cell index and carrier index.

Some embodiments include PDCCH configuration/monitoring. Method 1: Only on one carrier of the cell with multi-carrier. Method 2: On more than one carrier of the cell with multi-carrier and optionally PDCCH monitoring on one carrier at a time.

Some embodiments include DCI size and BD/CCE budget. Method 1: BD/CCE/DCI size budget per carrier is equal to legacy per cell budget, Method 2: all carrier is shared per cell budget, Method 3: scaling/configure or based on number of carriers. Other methods may include partial combination of the above methods: one of BD/CCE budget and DCI size budget is per cell, the other is per carrier.

In some embodiments, search space of MC-DCI is configured on, or BD/CCE/DCI size of the MC-DCI is counted on one cell and one/sub-set/each carrier. The n_CI in the search space equation is determined by cell index and carrier index, or another configured value for a cell in case the set of carriers are all included in the cell.

Some embodiments include Multi-TTI/repetition transmission on a cell with multi-carrier, including each SLIV combined with carrier index, and/or repetition with hopping among more than one carrier.

In some embodiments, DCI fields used for the cell with multi-carrier. (1) Carrier or UL only SCell adding/release or (de)activation may be based on BWP indicator and change to Type 1B, or a carrier indicator. (2) each bit of SCell and/or carrier dormancy indication may be used to represent one or a group of cells with all carriers, or one or a group of carriers with paired DL/UL carrier, or one or a group of DL carrier, or one or a group of UL carrier. (3) PDCCH monitoring adaptation indication can be applied on all carrier or combined with carrier adaptation indication in case PDCCH monitoring on more than one carrier.

In various embodiments in the present disclosure, MC-DCI may refer to either or all of the following: multi-cell scheduling downlink control information, and/or multi-carrier scheduling downlink control information.

The present disclosure describes methods, apparatus, and computer-readable medium for wireless communication. The present disclosure addressed the issues with scheduling mechanism with multiple carriers in one cell. The methods, devices, and computer-readable medium described in the present disclosure may facilitate the performance of wireless communication by resolving issues/problems associated with resource determination mechanism with MC-DCI, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, performed by a wireless communication device, comprising:
receiving a configuration comprising scheduling information for a carrier in a cell, wherein the cell comprises a plurality of carriers; and
deriving a set of parameters of the configuration for the carrier.

2. The method according to claim 1, wherein:
the configuration comprises a serving-cell configuration; and
the serving-cell configuration comprises at least one of the following:
in response to the cell being a scheduling cell, a scheduling carrier index of the scheduling carrier, wherein the scheduling carrier index indicates that one carrier in the scheduling cell is being used to schedule other carriers, or
in response to the cell being a scheduled cell, a scheduling cell index of the scheduling cell and the scheduling carrier index of the scheduling carrier, indicating that each carrier in the scheduled cell is configured as a scheduled carrier that is scheduled by another carrier.

3. The method according to claim 1, wherein:
the configuration comprises a serving-cell configuration; and
the serving-cell configuration comprises at least one of the following:
in response to the carrier being a scheduling carrier, an information element indicating it being a scheduling carrier, or
in response to the carrier being a scheduled carrier, the information element indicating it being a scheduled carrier, a scheduling cell index of the scheduling cell, and a scheduling carrier index of the scheduling carrier.

4. The method according to claim 1, wherein:
the configuration comprises a serving-cell configuration comprising a downlink configuration list; and
each downlink configuration corresponding to a downlink carrier comprises at least one of the following:
in response to the downlink carrier being a scheduling carrier, an information element indicating it being a scheduling carrier, or
in response to the downlink carrier being a scheduled carrier, the information element indicating it being a scheduled carrier, a scheduling cell index of the scheduling cell, and a scheduling carrier index of the scheduling carrier.

5. The method according to claim 1, wherein:
carrier indexes for at least one downlink carrier and at least one uplink carrier are configured independently by at least one of the following:
configuring a carrier index for the downlink carrier, or
configuring a carrier index for the uplink carrier, and
wherein at least one of the at least one downlink carrier is an anchor carrier and a carrier index for the anchor downlink carrier further comprises at least one of the following: the smallest index, or a default index.

6. The method according to claim 1, further comprising:
for multi-carrier scheduling, determining one of the following:
a maximum number of co-scheduled carriers,
a maximum number of co-scheduled cells comprising co-scheduled carriers, or
the maximum number of co-scheduled carriers and the maximum number of co-scheduled cells.

7. The method according to claim 1, wherein:
for multi-carrier scheduling, control channel is located on at least one of the following:
only one carrier of a cell with multiple carriers, or
more than one carrier of a cell comprising multiple carriers, and one of:
control channel monitoring on one carrier at a time by switching the more than one carrier for the control channel monitoring by a dynamic indication or a pre-configured pattern, or
the control channel monitoring same carriers with a blind decoding (BD) or a control channel element (CCE) scaling factor for the carriers of the cell.

8. The method according to claim 1, wherein:
a size budget is determined according to at least one of the following:
the size budget per carrier being equal to a pre-defined size budget per cell,
the size budget for all carriers per cell being equal to the pre-defined size budget per cell, or
the size budget for all carriers per cell being equal to or larger than the pre-defined size budget per cell, and being equal to or small than N times the pre-defined size budget per cell, wherein N is one of a number of carriers in one cell, a maximum number in one cell, or a value configured by a RRC signaling.

9. The method according to claim 8, wherein:
the size budget comprises at least one of the following: a BD size budget, a CCE size budget, or a DCI size budget, which are determined according to at least one of the following:
the DCI size budget per carrier being equal to a pre-defined DCI size budget per cell, and the BD size budget and the CCE size budget for all carriers per cell being equal to a pre-defined BD size budget and a pre-defined CCE size budget per cell, respectively, or
the BD size budget and the CCE size budget per carrier being equal to a pre-defined BD size budget and a pre-defined CCE size budget per cell, respectively, and the DCI size budget for all carriers per cell being equal to a pre-defined DCI size budget per cell.

10. The method according to claim 1, wherein:
for multi-cell scheduling downlink control information (MC-DCI), a DCI size budget, a BD size budget, and a CCE size budget of the MC-DCI is counted according to at least one of the following:
counted on one cell, and the DCI size budget, the BD size budget, and the CCE size budget for all carriers in one cell being equal to a pre-defined DCI, BD, and CCE size budget per cell, respectively,
counted on one carrier, and the DCI size budget, the BD size budget, and the CCE size budget per carrier being equal to a pre-defined DCI, BD, and CCE size budget per cell, respectively,
counted on one carrier or one cell, and the DCI size budget per carrier being equal to a pre-defined DCI size budget per cell, and determining the BD size budget and the CCE size budget for all carriers per cell being equal to a pre-defined BD size budget and a pre-defined CCE size budget per cell, respectively, or
counted on one carrier or one cell, and the BD size budget and the CCE size budget per carrier being equal to a pre-defined BD size budget and a pre-defined CCE size budget per cell, respectively, and determining the DCI size budget for all carriers per cell being equal to a pre-defined DCI size budget per cell.

11. The method according to claim 1, wherein:
for multi-cell scheduling downlink control information (MC-DCI), a search space of the MC-DCI is configured according to at least one of the following:
on each cell and each or a subset of carrier in the cell with a plurality of carriers,
on a subset of cells and each or a subset of carrier in the cell with a plurality of carriers,
on one cell and each or a subset of carrier in the cell with a plurality of carriers, or
on one cell and one carrier in the cell with a plurality of carriers.

12. The method according to claim 11, wherein:
a value used in a search space equation for configuring the search space of the MC-DCI is determined at least one of the following:
based on a cell index and a carrier index, or
based on a configured value for a cell in response to the cell comprises a set of carriers, wherein the configured value is different from a carrier indicator filed (CIF) of the cell.

13. The method according to claim 1, wherein:
for a plurality of data channel transmission on a cell with a plurality of carriers, at least one start and length indicator value (SLIV) of the plurality of data channel transmission is combined with a carrier index to indicate the carrier for data channel transmission, or
for a plurality of data channel transmission on a cell with a plurality of carriers, repetition with hopping among a plurality of carriers is configured.

14. The method according claim 1, wherein:
for a cell with a plurality of carriers scheduled by a downlink control information (DCI), the DCI comprises at least one of the following:
an indicator indicating carrier addition, release, activation, or deactivation;
the indicator indicating uplink only secondary cell (SCell) addition, release, activation, or deactivation;
each bit of SCell dormancy indication representing at least one cell with all carriers, at least one carrier with paired downlink-uplink carriers, at least one downlink carrier, or at least one uplink carrier;
each bit of carrier dormancy indication representing at least one cell with all carriers, at least one carrier with paired downlink-uplink carriers, at least one downlink carrier, or at least one uplink carrier; or
control channel monitoring adaptation indication applying on all carriers or combining with carrier adaptation indication in response to control channel monitoring on more than one carrier.

15. A method for wireless communication, performed by a wireless communication node, comprising:
determining a set of parameters of a configuration for a carrier in a cell, wherein the cell comprises a plurality of carriers; and
sending the configuration comprising scheduling information for the carrier.

16. The method according to claim 15, wherein:
the configuration comprises a serving-cell configuration; and
the serving-cell configuration comprises at least one of the following:
in response to the cell being a scheduling cell, a scheduling carrier index of the scheduling carrier, or
in response to the cell being a scheduled cell, a scheduling cell index of the scheduling cell and the scheduling carrier index of the scheduling carrier.

17. The method according to claim 15, wherein:
the configuration comprises a serving-cell configuration; and
the serving-cell configuration comprises at least one of the following:
in response to the carrier being a scheduling carrier, an information element indicating it being a scheduling carrier, or
in response to the carrier being a scheduled carrier, the information element indicating it being a scheduled carrier, a scheduling cell index of the scheduling cell, and a scheduling carrier index of the scheduling carrier.

18. The method according to claim 15, wherein:
the configuration comprises a serving-cell configuration comprising a downlink configuration list; and
each downlink configuration corresponding to a downlink carrier comprises at least one of the following:
in response to the downlink carrier being a scheduling carrier, an information element indicating it being a scheduling carrier, or
in response to the downlink carrier being a scheduled carrier, the information element indicating it being a scheduled carrier, a scheduling cell index of the scheduling cell, and a scheduling carrier index of the scheduling carrier.

19. The method according to claim 15, wherein:
carrier indexes for at least one downlink carrier and at least one uplink carrier are configured independently by at least one of the following:
configuring a carrier index for the downlink carrier, or
configuring a carrier index for the uplink carrier.

20. The method according to claim 15, further comprising:
for multi-carrier scheduling, determining one of the following:
a maximum number of co-scheduled carriers,
a maximum number of co-scheduled cells comprising co-scheduled carriers, or
the maximum number of co-scheduled carriers and the maximum number of co-scheduled cells.
